(19) United States
(12) Patent Application Publication
(10) Pub. No.: US 2012/0028111 A1
(43) Pub. Date: Feb. 2, 2012

(54) FULLY MAINTENANCE-FREE SEALING PLASTIC ACCUMULATOR COVER WITH DOUBLE COMPONENT OR O-RING

(76) Inventors: Ugur Gunduz, Istanbul (TR); Ali Unlu, Istanbul (TR)

(21) Appl. No.: 13/203,237

(22) PCT Filed: May 7, 2009
(86) PCT No.: PCT/TR2009/000056

§ 371 Date: Aug. 24, 2011

(30) Foreign Application Priority Data
Feb. 26, 2009 (TR) 2009/01451

(51) Int. Cl. H01M 2/08

(52) U.S. Cl. 429/175

(57) ABSTRACT

The invention is sealing plastic accumulator cover used in accumulators (1) so called as maintenance-free accumulator (1) having a secondary cover (4) on the body cover (3) and it is characterized in that it consists of at least one locking clamp (4.1) located on the said secondary cover (4) in order to provide fixing the said secondary cover (4) onto the said body cover (3) without use of welding and/or hot adhering, at least one clamp housing (3.1) located on the said body cover (3) and housing the said locking clamp (3.1), at least one sealing member (7) located between the said secondary cover (4) and the said body cover (3) in order to provide inner and/or external sealing of the said secondary cover (4) and the said body cover (3).

### THE RELATED ART

The invention relates to plastic and/or plastic derivative accumulator covers.

The invention particularly relates to sealing plastic accumulator cover used in accumulators having a secondary upper cover on the body called sealed system accumulator not requiring maintenance.

### BACKGROUND OF THE RELATED ART

Today the accumulators without maintenance used in vehicles are seen the embodiments frequently used. The said not requiring maintenance accumulators have a secondary cover on the body. It is called accumulator not requiring maintenance as the said secondary upper cover cannot be dismantled by user and therefore not subjected to maintenance.

In manufacture of accumulators not requiring maintenance, lead oxide paste and additive paste determining the feature of the plate is put onto the steel grids and tightened and dried to form the plates.

The plates are grouped and separators are located between them, then they are located in the cells on the body. An accumulator consists of six cells on its body. The cells are connected to each other by spot welding method so as to enable operation energy stored in cells like serial connected batteries.

After this process, body cover is adhered onto the body by melting plastic by help of hot plate (220-260 C). Sealing tests and leakage tests are applied and if the accumulator passes the tests, distilled water and diluted sulphuric acid is put up to 23 baume as electrolyte and the initial charging is conducted.

After charging process, accumulator is flushed at flushing machine as the body cover is polluted with acid residual, and is dried with air again. In order to adhere the secondary cover onto the body cover again, the surfaces should be clean and free of acid.

Then, the second cover and body cover are adhered to each other by welding with hot plate. A separate machine is used for this process. These machines are PLC controlled machines made of stainless steel and therefore they are considerably expensive.

The machines used in the applied covering method cause occupation of place in manufacture area as well as time, water and compressed air loss for flushing process. The expenses incurred for purification of water used in acid cleaning and air as well as the detergent and the adverse impacts caused by such factors on the environment are other highlighted disadvantages. The chemicals used to clean the acid and acids tried to be cleaned cause adverse impacts on health of the employees and just because of this reason, the employee carrying out this work are required to have check-ups at certain intervals.

Moreover, any fault that occurs during the said welding process means fully waste of accumulator and this will be a loss on account of the producer.

In the related art, European Patent application numbered EP1589596 discloses a maintenance-free accumulator cover embodiment. The secondary upper cap is located on the body cover through a joining member and sealing is provided by means of hot adhering method.

Similarly, European Patent Application numbered EP178422 discloses en embodiment in which secondary upper cover is connected into the house drilled on the body cover by means of welding method.

Because of the disadvantages mentioned above, it has been necessary to make a novelty in upper cover embodiment of maintenance-free accumulators.

### PURPOSE OF THE INVENTION

From this status of the related art, the purpose of the invention is to disclose a maintenance-free accumulator cover embodiment eliminating the said disadvantages.

Another purpose of the invention is to provide an embodiment not requiring use of an additional machine for performance of the said adhering and/or welding process as adhering and/or welding process required for ensuring acid leakage sealing in the said maintenance-free accumulator is not conducted.

A further purpose of the invention is to disclose an embodiment minimizing the manufacturing cost and time as additional adhering and/or welding machine is not used.

A further purpose of the invention is to disclose an embodiment eliminating employment of an additional qualified employee to use the said machine as an additional adhering and/or welding machine is not used.

Another purpose of the invention is to disclose an embodiment eliminating the requirement for flushing the acid before location of the secondary cover onto the body cover.

A further purpose of the invention is to disclose an embodiment eliminating the additional costs such as acid flushing machine, water, air and labour cost and shortening manufacturing time since acid flushing process is not conducted.

Another purpose of the invention is to overcome impacts on human health and environment caused by chemicals and acid used during acid flushing.

A further purpose of the invention is to provide saving in place on manufacturing area as adhering and acid flushing units are not used.

Another purpose of the invention is to disclose an embodiment eliminating the wastes encountered due to any faults which might occur during performance of welding and/or adhering process and cause replacement of accumulator fully.

A further purpose of the invention is to disclose an embodiment allowing dismantling the upper cover in case of any problem in the tests conducted after mounting and replacement of it with new one.

Another purpose of the invention is to disclose an embodiment easy to install but difficult for user to demount.

### DESCRIPTION OF FIGURES

FIG. 1 shows a view displaying dismantled plastic accumulator cover being subject of the invention.

FIG. 2 shows a perspective view of the accumulator being subject of the invention.

FIG. 3 shows a detailed view of the locking clamp

FIG. 4 shows a detailed view of the clamp housing.

FIG. 5 shows a cross-section view of an embodiment of plastic accumulator cover being subject of the invention.

FIG. 6 shows a cross-section view of a different embodiment of plastic accumulator cover being subject of the invention.

FIG. 7 shows a cross-section view of a different embodiment of plastic accumulator cover being subject of the invention.

### REFERENCE NUMBERS

1. Accumulator
2. Body
3. Body cover
3.1 Clamp housing
3.1.1 Locking Housing
3.1.2 Fixing bulge
4. Secondary cover
4.1 Locking clamp
4.1.1 Locking tip
4.1.2 Fixing Feeder
5. Accumulator Cell
6. Holder
7. Sealing member
7.1 O-ring
7.2 Thermoplastic elastomeric layer
8. Crushing Clamp

### DETAILED DESCRIPTION OF THE INVENTION

The invention relates to sealing plastic accumulator cover used in so called maintenance-free accumulators (1), having a secondary upper cover (4) on the body cover (3).

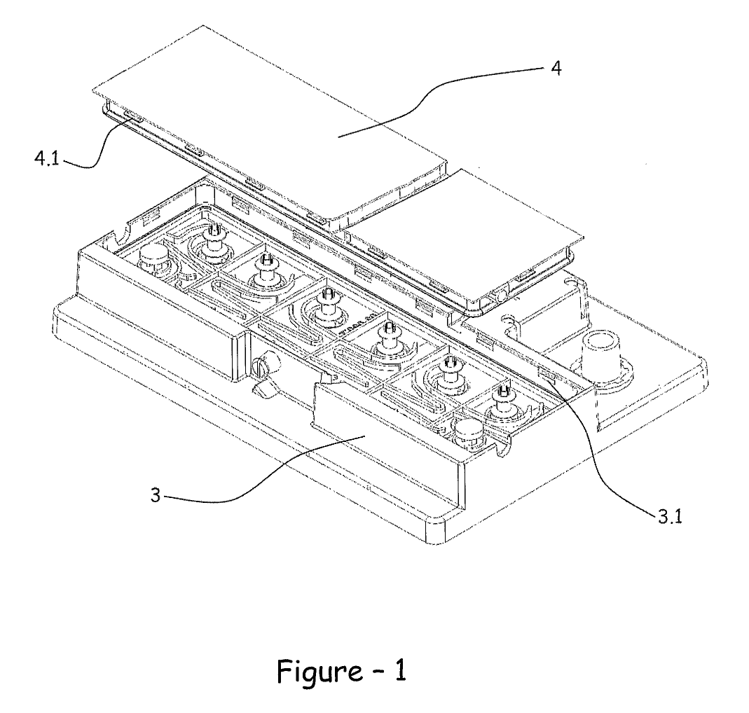

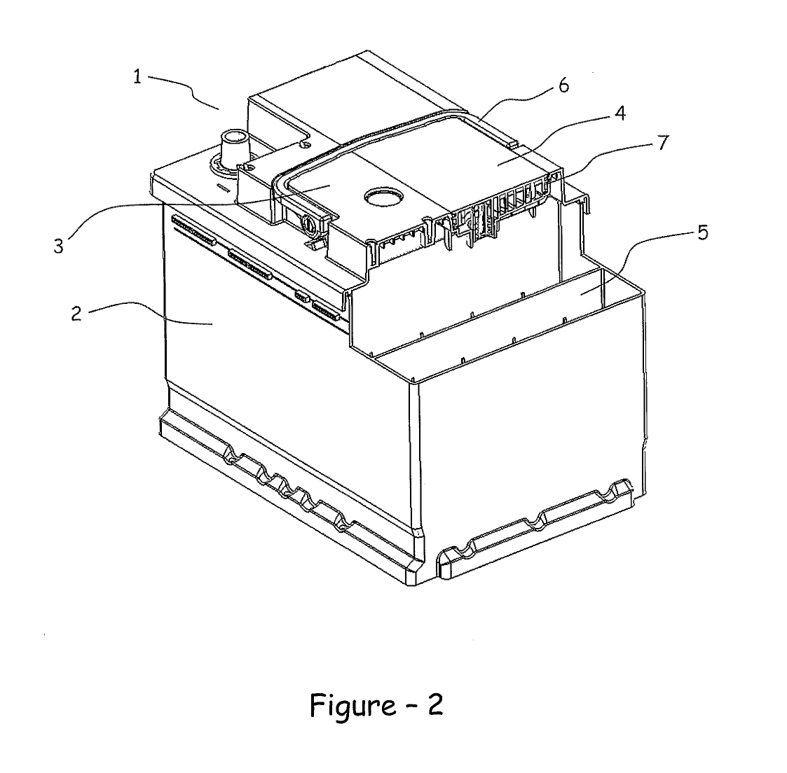

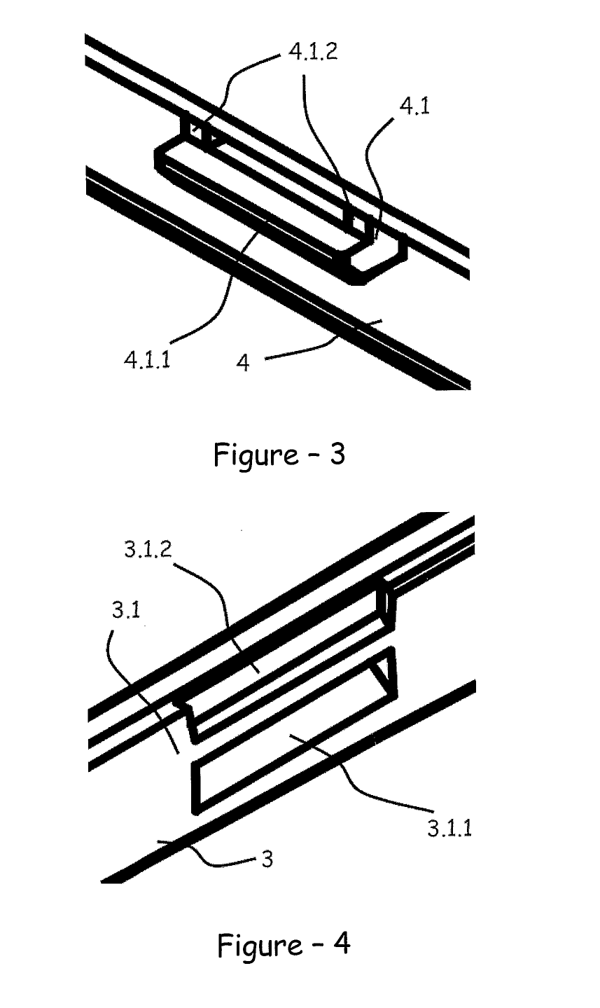

FIG. 1 shows a view displaying dismantled plastic accumulator cover being subject of the invention.

The said plastic accumulator cover consists of main parts of at least one body cover (3) located on the accumulator body (2), at least one secondary cover (4) located on the said body cover (3), at least one interlocking clamp (4.1) providing fixing of the said two covers (3, 4) onto each other without welding and/or hot adhering and located on the said secondary cover (4), at least one clamp housing (3.1) housing the said locking clamp (4.1) and located on the said body cover (3) and at least one sealing member (7) providing sealing between the said two covers (3,4).

The accumulator cell (5) located on the body (2) forming the main frame of the said accumulator (1) is the place where the energy is stored. After charging the accumulator (1) through the said accumulator cells (5), it is covered with the body cover (3). The holder (6) located on the said body cover (3) is an embodiment for easy carrying the accumulator (1).

In order to provide fixing the said secondary cover (4) onto the body cover (3), a locking clamp (4.1) is located on the secondary cover (4). Likely to be located in one or more than one in different embodiments of the invention, the clamps (4.1) are housed by clamp housing (3.1) drilled on the body cover (3).

The said locking clamp (4.1) consists of locking tip (4.1.1) and fixing feeder (4.1.2). The said locking tip (4.1.1) locks into the locking housing (3.1.1) located on the said clamp housing (3.1), while the fixing feeder (4.1) sits into the fixing bulge (3.1.2) located on the said clamp housing (3.1) and thus fixing process is realized.

When it is desired to dismantle the said secondary cover (4) from the body cover (3), the said clamp housing (3) and locking clamp (4) do not allow removal of them due to their locations in the nature preventing such action. The technical service intending to replace the cover can realize this process by dividing the secondary cover (4) from middle into two.

When it is desired to remove the said secondary cover (4) from the body cover (3), the said fixing feeder (4.1.2) applies counter resistance and prevents such attempt.

Fixing the said body cover (3) and secondary cover (4) onto each other is not adequate for providing sealing. For that reason, a sealing member (7) is located between the body cover (3) and secondary cover (4) in a manner preventing liquid passage.

The function performed by the said sealing member (7) is the same and changes can be made in practice as per the manufacturer and/or consumer's requests. Three illustrative samples of application of the said sealing member (7) have been provided below.

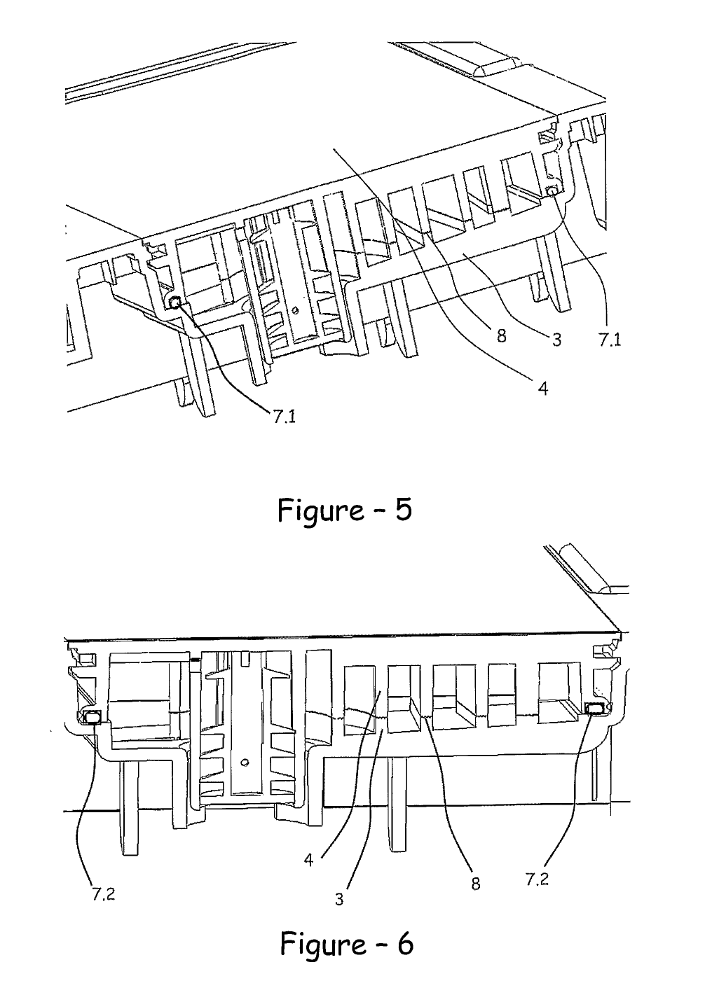

FIG. 5 shows a cross-section view of an embodiment of plastic accumulator cover being subject of the invention.

In the said embodiment, rubber or thermoplastic elastomeric (TPE) based O-Ring (7.1) is used to provide sealing between the body cover (3) and the secondary cover (4). In other words, the sealing member (7) in the said embodiment is O-ring (7.1). The sealing between the cells (5) of the said accumulator is provided by means of crushing clamps (8).

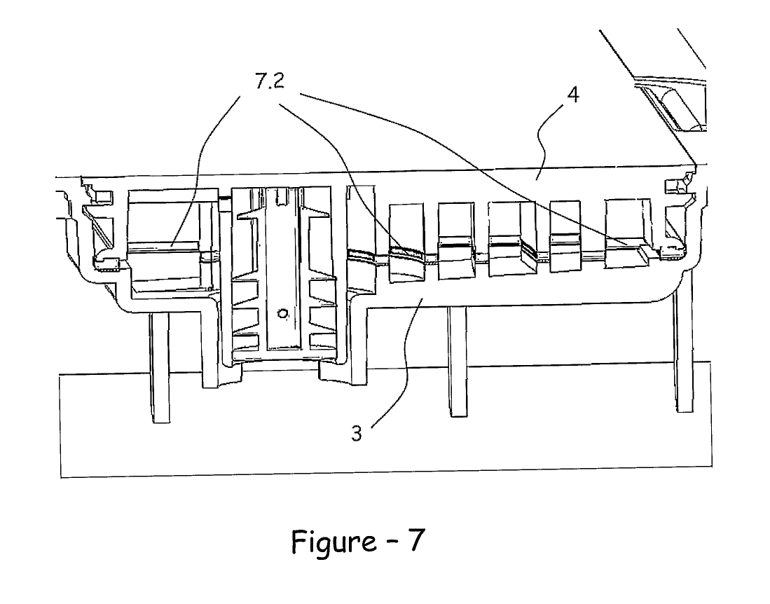

FIG. 6 shows a second embodiment of the invention and displays cross-section view of the said accumulator cover.

In the said embodiment, thermoplastic elastomeric based layer (7.2) is injected between the body cover (3) and the secondary cover (4) in order to provide sealing. Thermoplastic elastomeric layer (7.2) used as the said sealing member (7) performs the function of sealing against external atmosphere. Thus, sealing is provided by double component technique. The sealing in the internal ambience is provided by means of crushing clamps (8) again.

FIG. 7 shows a third embodiment of the invention and displays cross-section view of the said accumulator cover.

In the said embodiment, both internal and external sealing double components are used, in other words, thermoplastic elastomeric based layer (7.2) is injected between the body cover (3) and the secondary cover (4) longitudinally in order to provide sealing.

The protection scope of this application has been specified under claims and cannot be limited to the descriptions only given as sampling above. It is clear that any novelty can be provided by a person skilled in the related art by use of the similar embodiments and/or can also apply this embodiment in other areas for similar purposes used in the related art. Therefore, it is also clear that such embodiments lack of novelty criteria.

I claim:

1. A sealing plastic accumulator cover used in accumulators so called as maintenance-free accumulator having a secondary cover on a body cover comprising at least a locking clamp located on the secondary cover for fixing the secondary cover onto the body cover without use of welding or hot adhering; at least a clamp housing located on the body cover for housing the locking clamp; a sealing member for sealing of the secondary cover and the body cover against external or internal ambiance; and a thermoplastic elastomeric gasket type seal injected between the secondary cover and the body cover by using double component technique.

2. A sealing plastic accumulator cover according to claim 1 wherein the locking clamp comprises at least a locking tip locking into a locking housing located on the said clamp housing for providing positioning.

3. A sealing plastic accumulator cover according to claim 1 wherein the secondary cover comprising at least a fixing feeder for applying counter resistance when attempted to remove it from the body cover wherein the fixing feeder is located on the locking clamp.

4. A sealing plastic accumulator cover according to claim 2 wherein the secondary cover comprising at least a fixing feeder for applying counter resistance when attempted to remove it from the body cover wherein the fixing feeder is located on the locking clamp.

5. A sealing plastic accumulator cover according to claim 1 further comprising at least a fixing bulge located on the said clamp housing for preventing the movement of the locking clamp by fixing it into the clamp housing.

6. A sealing plastic accumulator cover according to claim 2 further comprising at least a fixing bulge located on the said clamp housing for preventing the movement of the locking clamp by fixing it into the clamp housing.

7. A sealing plastic accumulator cover according to claim 3 further comprising at least a fixing bulge located on the said clamp housing for preventing the movement of the locking clamp by fixing it into the clamp housing.

8. A sealing plastic accumulator cover according to claim 4 further comprising at least a fixing bulge located on the said clamp housing for preventing the movement of the locking clamp by fixing it into the clamp housing.
